(19) United States
(12) Patent Application Publication
(10) Pub. No.: US 2019/0004978 A1
(43) Pub. Date: Jan. 3, 2019

(54) SECURITY ROLE IDENTIFIER POOLS ALLOCATION

(71) Applicant: Intel Corporation, Santa Clara, CA (US)

(72) Inventors: Michael C. Neve De Mevergnies, Beaverton, OR (US); Reouven Elbaz, Portland, OR (US)

(21) Appl. No.: 15/640,177

(22) Filed: Jun. 30, 2017

(51) Int. Cl. G06F 13/16; G06F 21/57; G06F 21/51; G06F 3/06

(52) U.S. Cl. CPC G06F 13/16; G06F 21/572; G06F 3/0668; G06F 21/51; G06F 3/062; G06F 21/575

(57) ABSTRACT

Various systems and methods for Security Attributes of Initiator (SAI) pools allocation are described herein. A system for security attribute pool allocation includes an integrated circuit to: access a hardware block and store a security identifier in the hardware block, the security identifier being from a pool of security identifiers, the pool being one of a plurality of pools of security identifiers with each of the plurality of pools having mutually exclusive sets of security identifiers.

### TECHNICAL FIELD

Embodiments described herein generally relate to access control systems, and in particular, to systems and methods for allocation of security identifier pools.

### BACKGROUND

Security is an ever increasingly important area in computing and computer systems. While many security attacks are targeted at the software executing on a computer system, some attacks may be directed to underlying hardware. In an effort to curtail such hardware-based attacks, system architects have developed hardware and firmware security measures. One such mechanism is an access control system that regulates interactions between various hardware-level devices.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an exemplary hardware and software architecture microarchitecture of a computing device, in which various interfaces between hardware components and software components are shown, according to an embodiment;

FIG. 2 is a block diagram illustrating processing devices, according to an embodiment;

FIG. 3 is a block diagram illustrating a microarchitecture, according to an embodiment:

FIG. 4 is a diagram illustrating Security Attributes of Initiator (SAI) pool allocation, according to an embodiment;

FIG. 5 is a diagram illustrating SAI pool allocation, according to an embodiment;

FIG. 6 is a flowchart illustrating a method of security attribute pool allocation, according to an embodiment;

FIG. 7 is a flowchart illustrating a method of using security identifiers, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Hardware-level access control may be implemented with a bit string. This bit string may be referred to as a Security Attributes of Initiator (SAI) and is used to represent the security role of a hardware block at the source of the transaction. Each hardware block may have its own SAI. Multiple hardware blocks may be combined under a role, which may have an associated SAI. A hardware block may be associated with multiple roles, each having its own SAI.

The SAI is used both to identify the hardware block or its role, and also to serve as an index into one or more access control registers. A bit operation is used to translate the SAI into an index, which is then used to identify a bit in an access control register. If the bit is “1” then the access is allowed, otherwise the access is denied. The access control registers are required to control three aspects, including 1) read accesses (Read Access Control (RAC)), 2) write accesses (Write Access Control (WAC)), and 3) control policy (CP) (who is allowed to change the read and write policies). The access control policy registers are defined to protect access to a group of registers/assets sharing the same security requirements. It is possible for a hardware block to have more than one such policy group, where each policy group is composed of RAC/WAC and CP registers.

Conventionally, a 6-bit SAI hardware identifier allows for a maximum of 64 bits in an access control register. Although the smaller index (e.g., 6-bit versus 8-bit) reduces the size of access control registers to 64 bits, the 6-bit length limits the number of SAIs. The complexity of products has increased over time and more modern products have run out of SAIs for hardware components. Thus, due to the increased complexity of products with more hardware components, richer flows, and more use models, the number of SAs have become scarce. Some hardware components have transitioned to an 8-bit SAI, however this introduces operability and compatibility issues. While many newer modern platforms use an 8-bit SAI, which increases the number of available SAIs to 256, legacy platforms and hardware blocks use a 6-bit SAI. Redesigning and producing replacement hardware for 6-bit platforms would include additional hardware for four times as much register space (256-bit registers instead of 64-bit registers). Thus, due to the gate count impact and the large use of legacy hardware blocks, what is needed is a way to efficiently use an 8-bit SAI space for both 6-bit and 8-bit SAI allocation.

The present disclosure describes a mechanism to reduce the gate count pressure. Using a 256-bit SAI space, the 256 SAI set is split into multiple groups. In an embodiment, one group is for SAI issued from the Core, one group for non-Core usages, and the third group of remaining SAIs. The number and size of the groups may be of any size depending on system design requirements.

Additionally, an 8-bit-to-6-bit translation circuit is implemented on legacy 6-bit aware hardware, allowing current and future generations of 8-bit SAI hardware to interface with legacy 6-bit hardware. It is understood that the 8-to-6-bit translation discussed herein may be extended to encompass any m-to-n-bit translation where m>n.

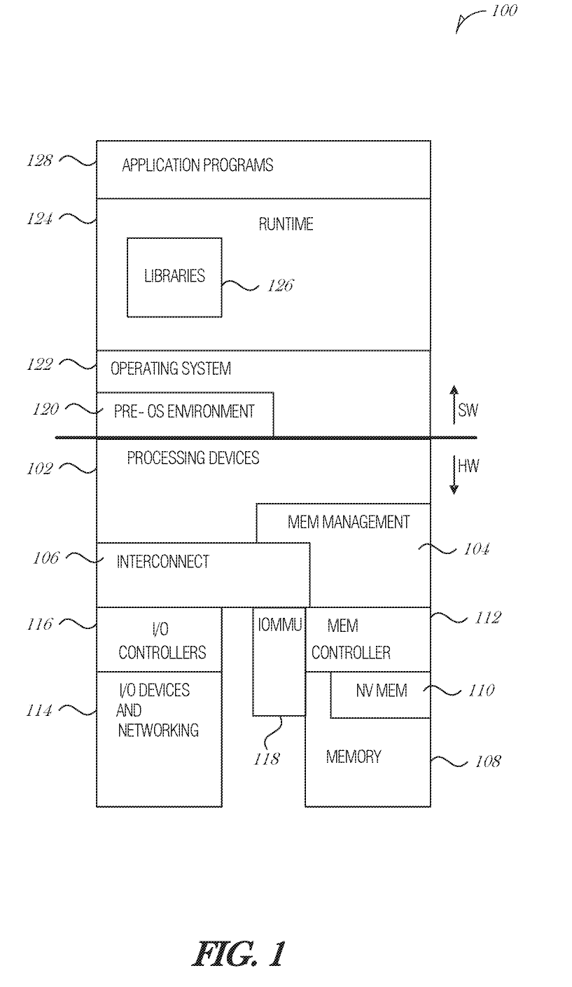

FIG. 1 is a diagram illustrating an exemplary hardware and software architecture microarchitecture 100 of a computing device, in which various interfaces between hardware components and software components are shown, according to an embodiment. As indicated by HW, hardware components are represented below the divider line, whereas software components denoted by SW reside above the divider line. On the hardware side, processing devices 102 (which may include one or more microprocessors, digital signal processors, etc., each having one or more processor cores, are interfaced with memory management device 104 and system interconnect 106. Memory management device 104 provides mappings between virtual memory used by processes being executed, and the physical memory. Memory management device 104 may be an integral part of a central processing unit which also includes the processing devices 102.

Interconnect 106 includes a backplane such as memory, data, and control lines, as well as the interface with input/output devices. e.g., PCI, USB, etc. Memory 108 (e.g., dynamic random access memory—DRAM) and non-volatile memory 110 such as flash memory (e.g., electrically-erasable read-only memory—EEPROM, NAND Flash, NOR Flash, etc.) are interfaced with memory management device 104 and interconnect 106 via memory controller 112. This architecture microarchitecture 100 may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 114, which interface with interconnect 106 via corresponding I/O controllers 116.

In a related embodiment, input/output memory management unit IOMMU 118 supports secure direct memory access (DMA) by peripherals. IOMMU 118 may provide memory protection by meditating access to memory 108 from I/O device 114. IOMMU 118 may also provide DMA memory protection in virtualized environments, where it allows certain hardware resources to be assigned to certain guest VMs running on the system, and enforces isolation between other VMs and peripherals not assigned to them.

On the software side, a pre-operating system (pre-OS) environment 120, which is executed at initial system start-up and is responsible for initiating the boot-up of the operating system. One traditional example of pre-OS environment 120 is a system basic input/output system (BIOS). In present-day systems, a unified extensible firmware interface (UEFI) may be implemented. Pre-OS environment 120, is responsible for initiating the launching of the operating system, but also provides an execution environment for embedded applications.

Operating system (OS) 122 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 122 provides device drivers, and a variety of common services such as those that facilitate interfacing with peripherals and networking, that provide abstraction for application programs so that the applications do not need to be responsible for handling the details of such common operations. Operating system 122 additionally provides a graphical user interface (GUI) that facilitates interaction with the user via peripheral devices such as a monitor, keyboard, mouse, microphone, video camera, touchscreen, and the like.

Runtime system 124 implements portions of an execution model, including such operations as putting parameters onto the stack before a function call, the behavior of disk input/output (I/O), and parallel execution-related behaviors. Runtime system 124 may also perform support services such as type checking, debugging, or code generation and optimization.

Libraries 126 include collections of program functions that provide further abstraction for application programs. These include shared libraries, dynamic linked libraries (DLLs), for example. Libraries 126 may be integral to the operating system 122, runtime system 124, or may be added-on features, or even remotely-hosted. Libraries 126 define an application program interface (API) through which a variety of function calls may be made by application programs 128 to invoke the services provided by the operating system 122. Application programs 128 are those programs that perform useful tasks for users, beyond the tasks performed by lower-level system programs that coordinate the basis operability of the computing device itself.

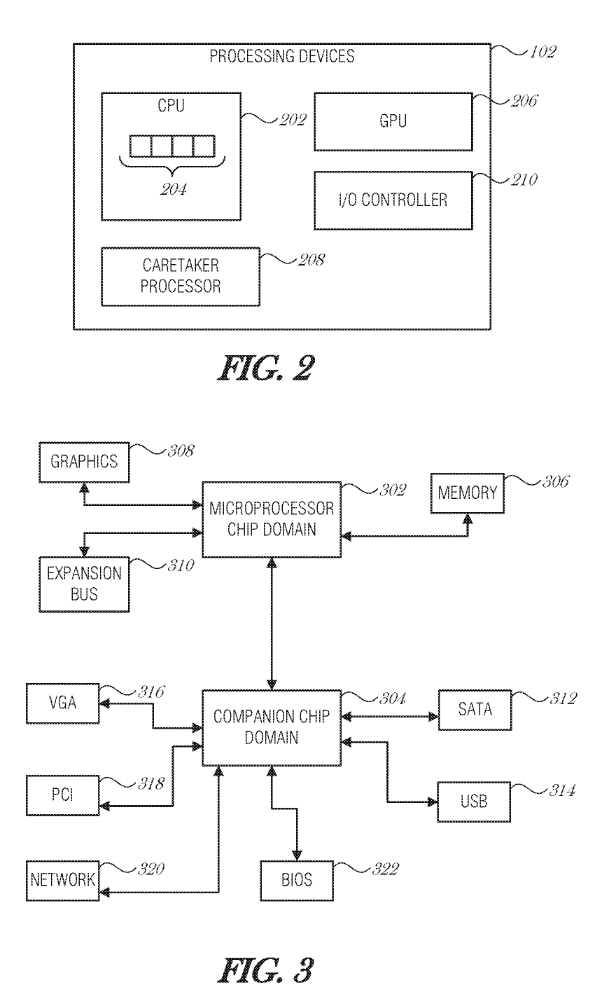

FIG. 2 is a block diagram illustrating processing devices 102, according to an embodiment. In an embodiment, two or more of processing devices 102 depicted are formed on a common semiconductor substrate. CPU 202 may contain one or more processing cores 204, each of which has one or more arithmetic logic units (ALU), instruction fetch units, instruction decode units, control units, registers, data stack pointers, program counters, and other components according to the particular architecture of the processor 202. As an illustrative example, CPU 202 may be an x86-type of processor. Processing devices 102 may also include a graphics processing unit (GPU) 206. In these embodiments. GPU 206 may be a specialized co-processor that offloads certain computationally-intensive operations, particularly those associated with graphics rendering, from CPU 202. Notably, CPU 202 and GPU 206 generally work collaboratively, sharing access to memory resources, I/O channels, etc.

Processing devices 102 may also include caretaker processor 208 in some embodiments. Caretaker processor 208 generally does not participate in the processing work to carry out software code as CPU 202 and GPU 206 do. In some embodiments, caretaker processor 208 does not share memory space with CPU 202 and GPU 206, and is therefore not arranged to execute operating system or application programs. Instead, caretaker processor 208 may execute dedicated firmware that supports the technical workings of CPU 202, GPU 206, and other components of the computer system. In some embodiments, caretaker processor 208 is implemented as a microcontroller device, which may be physically present on the same integrated circuit die as CPU 202, or may be present on a distinct integrated circuit die. Caretaker processor 208 may also include a dedicated set of I/O facilities to enable it to communicate with external entities. In an embodiment, caretaker processor 208 is implemented using a manageability engine (ME) or platform security processor (PSP). In another embodiment, caretaker processor 208 may take the form of a power control unit (PCU) in some system architectures.

Input/output (I/O) controller 210 coordinates information flow between the various processing devices 202, 206, 208, as well as with external circuitry, such as a system interconnect or main memory (e.g., DRAM).

FIG. 3 is a block diagram illustrating a microarchitecture 300, according to an embodiment. The microarchitecture 300 includes a microprocessor chip domain 302 and a companion chip domain 304 connected over a high-speed interface (e.g., Direct Media Interface).

The microprocessor chip domain 302 includes one or more processor cores, memory controller, display controllers, and the like, while the companion chip domain 304 includes controllers and other circuitry to interface with peripheral devices. In the past, some processors were paired with two companion chips, often called the “north bridge” and “south bridge,” or the memory controller hub (MCH) and input/output controller hub (ICH), respectively. In more modern processors, the functions of the north bridge are included in the processor itself and the south bridge has been replaced with a controller hub (e.g., platform controller hub (PCH)). As such, for this document, the term “microprocessor chip domain” includes modern processors that incorporate the north bridge, legacy processors that have a separate north bridge, and other configurations. The “companion chip domain” includes controllers and co-processors that provide additional input/output functions that support the microprocessor chip domain. The “companion chip domain” may refer to a south bridge architecture in some embodiments.

The microprocessor chip domain 302 interfaces with memory 306, graphics ports 308, and high-speed expansion busses 310. Memory 306 may include various memory types including dual channel, double data-rate (DDR) DRAM, or the like. Graphics ports 308 may provide support for DisplayPort (DP), Digital Visual Interface (DVI), High-Definition Multimedia Interface (HMDI), or the like. High-speed expansion busses 310 include Peripheral Component Interconnect Express (PCIe), and the like.

The companion chip domain 304 provides support interfaces for peripheral devices, such as Serial ATA 312, Universal Serial Bus (USB) 314, Analog VGA 316, expansion card busses 318 (e.g., PCI, PCIe, etc.), network interfaces 320 (e.g., Ethernet), and BIOS 322.

The microprocessor chip domain 302 and companion chip domain 304 may be integrated as separate chips or on a single chip with integrated controllers. Multiple-chip implementations provide higher performance and more expansion capability. Single-chip implementations may be optimized for small size and low cost. The actual architectural arrangement is dependent on the design of the target platform.

The processors, memory, accelerators, and other devices illustrated in FIGS. 1-3 may interact with each other to process workloads handled by the computing device. Components that initiate such workflows and use system resources are referred to herein as “initiators.” The SAI may be communicated with each transaction initiated by the initiator of the transaction. Unlike other identifiers (IDs), such as source IDs, SAIs do not get transformed at bridges; they persist until the point of policy enforcement. The SAI is used to control the access to the asset in the target receiving the transaction. The SAI that accompanies the transaction serves as an index into various access control registers. These access control registers contain the read and write permissions that are defined for each initiator by the system architect.

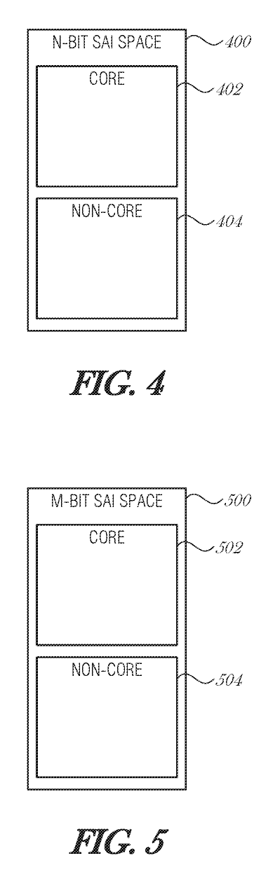

FIG. 4 is a diagram illustrating SAI pool allocation, according to an embodiment. SAI space is defined by the number of bits that are used to index into a register. An n-bit SAI space 400 is divided into two or more mutually exclusive pools, including a core pool 402 and a non-core pool 404. The core pool 402 may be used to define SAIs for hardware blocks that exist in a microprocessor chip domain, such as a processor core. The non-core pool 404 may be used to define SAIs for hardware blocks in a companion chip domain, such as a USB device. In this manner, as generations of microprocessor chip domain chip sets are released, so long as they only use SAIs from the core pool 402, the system architect will be assured that the SAIs used will not conflict with any companion chip domain SAIs. Similarly, as generations of companion chip domain chip sets are released, the architect may use SAIs from the non-core pool 404 and be assured that they will not have SAI conflicts with SAIs from the core pool 402.

It is understood that additional or different pools may be used in the allocation of the n-bit SAI space. The use of a reserved pool, for example, may be used to allow for flexibility in later system design. SAIs from the reserved pool may be assigned to the core pool 402, for example, to allow for additional flows. As usages evolve, the core SAI may become obsolete and the core pool 402 may shrink, allocating one or more SAIs back to the reserved pool.

FIG. 5 is a diagram illustrating SAI pool allocation, according to an embodiment. As with the pool allocation illustrated in FIG. 4, an m-bit SAI space 500 may be divided into two or more mutually exclusive pools, including a core pool 502 and a non-core pool 504. The pool allocation illustrated in FIG. 5 may coexist with the pool allocation in FIG. 4 when m>n. A translation function (or reduction function) may be used to map the m-bit domain onto the n-bit range, while preserving the pool allocation of the n-bit SAI space.

For instance, if m=8 and n=6, then the 6-bit space may be divided up into various pools. The 6-bit space may be mapped by way of a reduction function using 8-bit vectors. The remaining available 8-bit space may be extended. A corresponding set of pools is allocated for the 8-bit SAIs that do not map to the 6-bit space. The 8-bit pools may be reserved for hardware blocks that are able to use the full 8 bits of the SAI field-those that do not implement the 8-to-6-bit mapping. This extension enables the system architect to get an additional SAIs for 8-bit usage while remaining fully backward compatible with 6-bit usage.

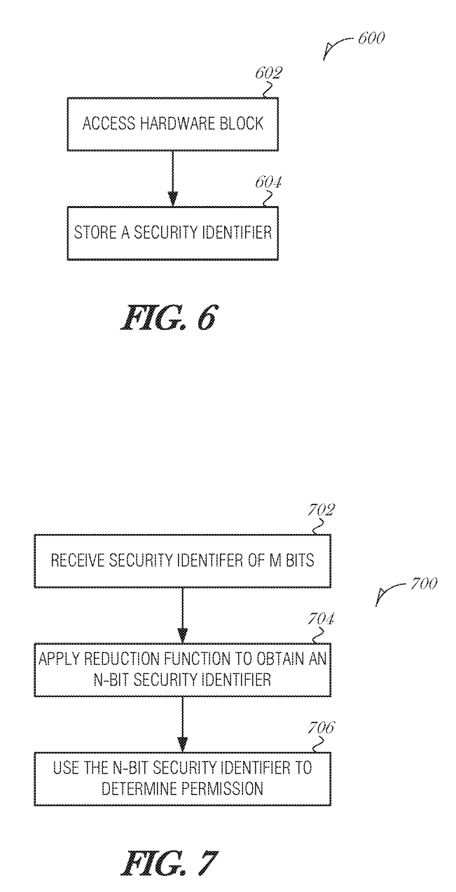

FIG. 6 is a flowchart illustrating a method 600 of security attribute pool allocation, according to an embodiment. At 602, a hardware block is accessed. In an embodiment, the hardware block comprises a processor core. In an embodiment, the hardware block comprises input/output device. It is understood that the hardware block may represent any portion of a microarchitecture, including but not limited to processor cores, graphics controllers, memory controllers, I/O controllers, and the like.

At 604, a security identifier is stored in the hardware block, the security identifier being from a pool of security identifiers, the pool being one of a plurality of pools of security identifiers with each of the plurality of pools having mutually exclusive sets of security identifiers.

In an embodiment, the security identifier comprises an 8-bit security attributes of initiator value. In an embodiment, the security identifier comprises a 6-bit security attributes of initiator value. It is understood that any number of bits may be used in the security attributes of initiator value.

In an embodiment, the pool of security identifiers comprises a core pool. In an embodiment, the pool of security identifiers comprises a non-core pool. In an embodiment, the pool of security identifiers comprises a north bridge pool. In an embodiment, the pool of security identifiers comprises a south bridge pool. In an embodiment, the pool of security identifiers comprises a reserve pool.

In an embodiment, the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool. The hardware types may be grouped by north bridge, south bridge, PCH, core, chassis, etc.

In a further embodiment, the first pool and second pool are arranged to allow a system designer to use an arbitrary version of the first type of hardware with an arbitrary version of the second type of hardware without producing a security identifier conflict. Example versions of hardware types include, but are not limited to, Sandy Bridge, Ivy Bridge, Haswell, Broadwell, Skylake, Kaby Lake, and the like from Intel Corporation; or K8, K10, Phenom, Manchester, Toledo, Windsor, and Brisbane from Advanced Micro Devices, Inc.

FIG. 7 is a flowchart illustrating a method 700 of using security identifiers, according to an embodiment. At 702, a security identifier having a length of m bits, is received at an access-controlled hardware element, which was transmitted to the access-controlled hardware element from a requesting hardware block, where the security identifier transmitted was transmitted with a requested operation. In an embodiment, the requesting hardware block comprises a processor core. In an embodiment, the requesting hardware block comprises a input/output device.

In an embodiment, the access-controlled hardware element comprises a memory device. In an embodiment, the access-controlled hardware element comprises a graphics output device.

In an embodiment, the security identifier comprises a security attributes of initiator (SAI) value.

At 704, a reduction function is applied to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers. In an embodiment, the security identifier comprises an 8-bit security attributes of initiator value, and applying the reduction function results in a 6-bit security attributes of initiator value.

In an embodiment, the pool of security identifiers comprises a core pool. In an embodiment, the pool of security identifiers comprises a non-core pool. In an embodiment, the pool of security identifiers comprises a north bridge pool. In an embodiment, the pool of security identifiers comprises a south bridge pool. In an embodiment, the pool of security identifiers comprises a reserve pool.

At 706, the n-bit security identifier is used to determine whether the requesting hardware block is permitted to perform the requested operation.

In an embodiment, the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool. In a further embodiment, the first pool and second pool are arranged to allow a system designer to use an arbitrary version of the first type of hardware with an arbitrary version of the second type of hardware without producing a security identifier conflict.

In an embodiment, using the n-bit security identifier comprises referencing a bit register to determine a value of a bit at a position in the bit register that corresponds with the n-bit security identifier; and permitting or denying access to the access-controlled hardware element based on the value of the bit at the position in the bit register.

In an embodiment, using the n-bit security identifier comprises comparing the n-bit security identifier to an expected value; and permitting or denying access to the access-controlled hardware element based on whether the n-bit security identifier corresponds with the expected value.

In an embodiment, the requested operation comprises a read operation. In a related embodiment, the requested operation comprises a write operation. In a related embodiment, the requested operation comprises a change policy operation.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

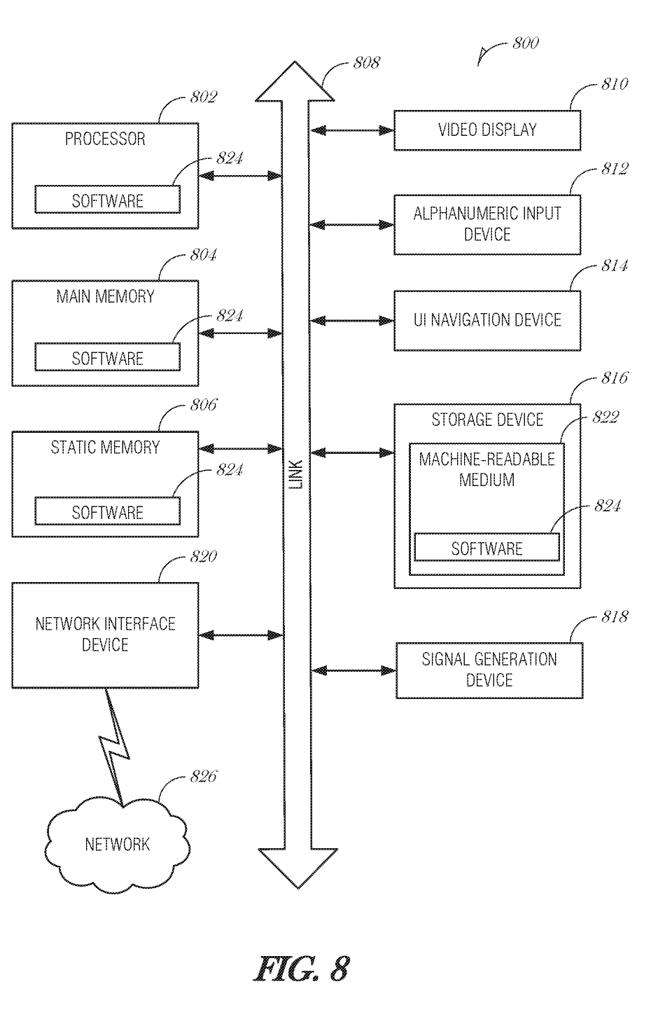

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, gyrometer, magnetometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for security attribute pool allocation, the system comprising: an integrated circuit to: access a hardware block; and store a security identifier in the hardware block, the security identifier being from a pool of security identifiers, the pool being one of a plurality of pools of security identifiers with each of the plurality of pools having mutually exclusive sets of security identifiers.

In Example 2, the subject matter of Example 1 optionally includes wherein the hardware block comprises a processor core.

In Example 3, the subject matter of any one or more of Examples 1-2 optionally include wherein the hardware block comprises input/output device.

In Example 4, the subject matter of any one or more of Examples 1-3 optionally include -bit security attributes of initiator value.

In Example 5, the subject matter of any one or more of Examples 1-4 optionally include -bit security attributes of initiator value.

In Example 6, the subject matter of any one or more of Examples 1-5 optionally include wherein the pool of security identifiers comprises a core pool.

In Example 7, the subject matter of any one or more of Examples 1-6 optionally include wherein the pool of security identifiers comprises a non-core pool.

In Example 8, the subject matter of any one or more of Examples 1-7 optionally include wherein the pool of security identifiers comprises a north bridge pool.

In Example 9, the subject matter of any one or more of Examples 1-8 optionally include wherein the pool of security identifiers comprises a south bridge pool.

In Example 10, the subject matter of any one or more of Examples 1-9 optionally include wherein the pool of security identifiers comprises a reserve pool.

In Example 11, the subject matter of any one or more of Examples 1-10 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 12, the subject matter of Example 11 optionally includes wherein the first pool and second pool are arranged to allow a system designer to use an arbitrary version of the first type of hardware with an arbitrary version of the second type of hardware without producing a security identifier conflict.

Example 13 is a method of security attribute pool allocation, the method comprising: accessing a hardware block; and storing a security identifier in the hardware block, the security identifier being from a pool of security identifiers, the pool being one of a plurality of pools of security identifiers with each of the plurality of pools having mutually exclusive sets of security identifiers.

In Example 14, the subject matter of Example 13 optionally includes wherein the hardware block comprises a processor core.

In Example 15, the subject matter of any one or more of Examples 13-14 optionally include wherein the hardware block comprises input/output device.

In Example 16, the subject matter of any one or more of Examples 13-15 optionally include -bit security attributes of initiator value.

In Example 17, the subject matter of any one or more of Examples 13-16 optionally include -bit security attributes of initiator value.

In Example 18, the subject matter of any one or more of Examples 13-17 optionally include wherein the pool of security identifiers comprises a core pool.

In Example 19, the subject matter of any one or more of Examples 13-18 optionally include wherein the pool of security identifiers comprises a non-core pool.

In Example 20, the subject matter of any one or more of Examples 13-19 optionally include wherein the pool of security identifiers comprises a north bridge pool.

In Example 21, the subject matter of any one or more of Examples 13-20 optionally include wherein the pool of security identifiers comprises a south bridge pool.

In Example 22, the subject matter of any one or more of Examples 13-21 optionally include wherein the pool of security identifiers comprises a reserve pool.

In Example 23, the subject matter of any one or more of Examples 13-22 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 24, the subject matter of Example 23 optionally includes wherein the first pool and second pool are arranged to allow a system designer to use an arbitrary version of the first type of hardware with an arbitrary version of the second type of hardware without producing a security identifier conflict.

Example 25 is at least one machine-readable medium including instructions, which when executed by a machine, cause the machine to perform operations of any of the methods of Examples 13-24.

Example 26 is an apparatus comprising means for performing any of the methods of Examples 13-24.

Example 27 is an apparatus for security attribute pool allocation, the apparatus comprising: means for accessing a hardware block; and means for storing a security identifier in the hardware block, the security identifier being from a pool of security identifiers, the pool being one of a plurality of pools of security identifiers with each of the plurality of pools having mutually exclusive sets of security identifiers.

In Example 28, the subject matter of Example 27 optionally includes wherein the hardware block comprises a processor core.

In Example 29, the subject matter of any one or more of Examples 27-28 optionally include wherein the hardware block comprises input/output device.

In Example 30, the subject matter of any one or more of Examples 27-29 optionally include -bit security attributes of initiator value.

In Example 31, the subject matter of any one or more of Examples 27-30 optionally include -bit security attributes of initiator value.

In Example 32, the subject matter of any one or more of Examples 27-31 optionally include wherein the pool of security identifiers comprises a core pool.

In Example 33, the subject matter of any one or more of Examples 27-32 optionally include wherein the pool of security identifiers comprises a non-core pool.

In Example 34, the subject matter of any one or more of Examples 27-33 optionally include wherein the pool of security identifiers comprises a north bridge pool.

In Example 35, the subject matter of any one or more of Examples 27-34 optionally include wherein the pool of security identifiers comprises a south bridge pool.

In Example 36, the subject matter of any one or more of Examples 27-35 optionally include wherein the pool of security identifiers comprises a reserve pool.

In Example 37, the subject matter of any one or more of Examples 27-36 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 38, the subject matter of Example 37 optionally includes wherein the first pool and second pool are arranged to allow a system designer to use an arbitrary version of the first type of hardware with an arbitrary version of the second type of hardware without producing a security identifier conflict.

Example 39 is at least one machine-readable medium including instructions for security attribute pool allocation, which when executed by a machine, cause the machine to perform the operations comprising: accessing a hardware block; and storing a security identifier in the hardware block, the security identifier being from a pool of security identifiers, the pool being one of a plurality of pools of security identifiers with each of the plurality of pools having mutually exclusive sets of security identifiers.

In Example 40, the subject matter of Example 39 optionally includes wherein the hardware block comprises a processor core.

In Example 41, the subject matter of any one or more of Examples 39-40 optionally include wherein the hardware block comprises input/output device.

In Example 42, the subject matter of any one or more of Examples 39-41 optionally include -bit security attributes of initiator value.

In Example 43, the subject matter of any one or more of Examples 39-42 optionally include -bit security attributes of initiator value.

In Example 44, the subject matter of any one or more of Examples 39-43 optionally include wherein the pool of security identifiers comprises a core pool.

In Example 45, the subject matter of any one or more of Examples 39-44 optionally include wherein the pool of security identifiers comprises a non-core pool.

In Example 46, the subject matter of any one or more of Examples 39-45 optionally include wherein the pool of security identifiers comprises a north bridge pool.

In Example 47, the subject matter of any one or more of Examples 39-46 optionally include wherein the pool of security identifiers comprises a south bridge pool.

In Example 48, the subject matter of any one or more of Examples 39-47 optionally include wherein the pool of security identifiers comprises a reserve pool.

In Example 49, the subject matter of any one or more of Examples 39-48 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 50, the subject matter of Example 49 optionally includes wherein the first pool and second pool are arranged to allow a system designer to use an arbitrary version of the first type of hardware with an arbitrary version of the second type of hardware without producing a security identifier conflict.

Example 51 is a system for using security identifiers, the system comprising: an integrated circuit to: receive, at an access-controlled hardware element, a security identifier having a length of m bits, transmitted to the access-controlled hardware element from a requesting hardware block, the security identifier transmitted with a requested operation; apply a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and use the n-bit security identifier to determine whether the requesting hardware block is permitted to perform the requested operation.

In Example 52, the subject matter of Example 51 optionally includes wherein the requesting hardware block comprises a processor core.

In Example 53, the subject matter of any one or more of Examples 51-52 optionally include wherein the requesting hardware block comprises a input/output device.

In Example 54, the subject matter of any one or more of Examples 51-53 optionally include wherein the access-controlled hardware element comprises a memory device.

In Example 55, the subject matter of any one or more of Examples 51-54 optionally include wherein the access-controlled hardware element comprises a graphics output device.

In Example 56, the subject matter of any one or more of Examples 51-55 optionally include wherein the security identifier comprises a security attributes of initiator value.

In Example 57, the subject matter of any one or more of Examples 51-56 optionally include -bit security attributes of initiator value.

In Example 58, the subject matter of any one or more of Examples 51-57 optionally include wherein the pool of security identifiers comprises a core pool.

In Example 59, the subject matter of any one or more of Examples 51-58 optionally include wherein the pool of security identifiers comprises a non-core pool.

In Example 60, the subject matter of any one or more of Examples 51-59 optionally include wherein the pool of security identifiers comprises a north bridge pool.

In Example 61, the subject matter of any one or more of Examples 51-60 optionally include wherein the pool of security identifiers comprises a south bridge pool.

In Example 62, the subject matter of any one or more of Examples 51-61 optionally include wherein the pool of security identifiers comprises a reserve pool.

In Example 63, the subject matter of any one or more of Examples 51-62 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 64, the subject matter of Example 63 optionally includes wherein the first pool and second pool are arranged to allow a system designer to use an arbitrary version of the first type of hardware with an arbitrary version of the second type of hardware without producing a security identifier conflict.

In Example 65, the subject matter of any one or more of Examples 51-64 optionally include wherein to use the n-bit security identifier, the integrated circuit is to: reference a bit register to determine a value of a bit at a position in the bit register that corresponds with the n-bit security identifier; and permit or deny access to the access-controlled hardware element based on the value of the bit at the position in the bit register.

In Example 66, the subject matter of any one or more of Examples 51-65 optionally include wherein to use the n-bit security identifier, the integrated circuit is to: compare the n-bit security identifier to an expected value; and permit or deny access to the access-controlled hardware element based on whether the n-bit security identifier corresponds with the expected value.

In Example 67, the subject matter of any one or more of Examples 65-66 optionally include wherein the requested operation comprises a read operation.

In Example 68, the subject matter of any one or more of Examples 65-67 optionally include wherein the requested operation comprises a write operation.

In Example 69, the subject matter of any one or more of Examples 65-68 optionally include wherein the requested operation comprises a change policy operation.

Example 70 is a method of using security identifiers, the method comprising: receiving, at an access-controlled hardware element, a security identifier having a length of m bits, transmitted to the access-controlled hardware element from a requesting hardware block, the security identifier transmitted with a requested operation; applying a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and using the n-bit security identifier to determine whether the requesting hardware block is permitted to perform the requested operation.

In Example 71, the subject matter of Example 70 optionally includes wherein the requesting hardware block comprises a processor core.

In Example 72, the subject matter of any one or more of Examples 70-71 optionally include wherein the requesting hardware block comprises a input/output device.

In Example 73, the subject matter of any one or more of Examples 70-72 optionally include wherein the access-controlled hardware element comprises a memory device.

In Example 74, the subject matter of any one or more of Examples 70-73 optionally include wherein the access-controlled hardware element comprises a graphics output device.

In Example 75, the subject matter of any one or more of Examples 70-74 optionally include wherein the security identifier comprises a security attributes of initiator value.

In Example 76, the subject matter of any one or more of Examples 70-75 optionally include -bit security attributes of initiator value.

In Example 77, the subject matter of any one or more of Examples 70-76 optionally include wherein the pool of security identifiers comprises a core pool.

In Example 78, the subject matter of any one or more of Examples 70-77 optionally include wherein the pool of security identifiers comprises a non-core pool.

In Example 79, the subject matter of any one or more of Examples 70-78 optionally include wherein the pool of security identifiers comprises a north bridge pool.

In Example 80, the subject matter of any one or more of Examples 70-79 optionally include wherein the pool of security identifiers comprises a south bridge pool.

In Example 81, the subject matter of any one or more of Examples 70-80 optionally include wherein the pool of security identifiers comprises a reserve pool.

In Example 82, the subject matter of any one or more of Examples 70-81 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 83, the subject matter of Example 82 optionally includes wherein the first pool and second pool are arranged to allow a system designer to use an arbitrary version of the first type of hardware with an arbitrary version of the second type of hardware without producing a security identifier conflict.

In Example 84, the subject matter of any one or more of Examples 70-83 optionally include wherein using the n-bit security identifier comprises: referencing a bit register to determine a value of a bit at a position in the bit register that corresponds with the n-bit security identifier; and permitting or denying access to the access-controlled hardware element based on the value of the bit at the position in the bit register.

In Example 85, the subject matter of any one or more of Examples 70-84 optionally include wherein using the n-bit security identifier comprises: comparing the n-bit security identifier to an expected value; and permitting or denying access to the access-controlled hardware element based on whether the n-bit security identifier corresponds with the expected value.

In Example 86, the subject matter of any one or more of Examples 84-85 optionally include wherein the requested operation comprises a read operation.

In Example 87, the subject matter of any one or more of Examples 84-86 optionally include wherein the requested operation comprises a write operation.

In Example 88, the subject matter of any one or more of Examples 84-87 optionally include wherein the requested operation comprises a change policy operation.

Example 89 is at least one machine-readable medium including instructions, which when executed by a machine, cause the machine to perform operations of any of the methods of Examples 70-88.

Example 90 is an apparatus comprising means for performing any of the methods of Examples 70-88.

Example 91 is an apparatus for using security identifiers, the apparatus comprising: means for receiving, at an access-controlled hardware element, a security identifier having a length of m bits, transmitted to the access-controlled hardware element from a requesting hardware block, the security identifier transmitted with a requested operation; means for applying a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and means for using the n-bit security identifier to determine whether the requesting hardware block is permitted to perform the requested operation.

In Example 92, the subject matter of Example 91 optionally includes wherein the requesting hardware block comprises a processor core.

In Example 93, the subject matter of any one or more of Examples 91-92 optionally include wherein the requesting hardware block comprises a input/output device.

In Example 94, the subject matter of any one or more of Examples 91-93 optionally include wherein the access-controlled hardware element comprises a memory device.

In Example 95, the subject matter of any one or more of Examples 91-94 optionally include wherein the access-controlled hardware element comprises a graphics output device.

In Example 96, the subject matter of any one or more of Examples 91-95 optionally include wherein the security identifier comprises a security attributes of initiator value.

In Example 97, the subject matter of any one or more of Examples 91-96 optionally include -bit security attributes of initiator value.

In Example 98, the subject matter of any one or more of Examples 91-97 optionally include wherein the pool of security identifiers comprises a core pool.

In Example 99, the subject matter of any one or more of Examples 91-98 optionally include wherein the pool of security identifiers comprises a non-core pool.

In Example 100, the subject matter of any one or more of Examples 91-99 optionally include wherein the pool of security identifiers comprises a north bridge pool.

In Example 101, the subject matter of any one or more of Examples 91-100 optionally include wherein the pool of security identifiers comprises a south bridge pool.

In Example 102, the subject matter of any one or more of Examples 91-101 optionally include wherein the pool of security identifiers comprises a reserve pool.

In Example 103, the subject matter of any one or more of Examples 91-102 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 104, the subject matter of Example 103 optionally includes wherein the first pool and second pool are arranged to allow a system designer to use an arbitrary version of the first type of hardware with an arbitrary version of the second type of hardware without producing a security identifier conflict.

In Example 105, the subject matter of any one or more of Examples 91-104 optionally include wherein the means for using the n-bit security identifier comprise: means for referencing a bit register to determine a value of a bit at a position in the bit register that corresponds with the n-bit security identifier; and means for permitting or denying access to the access-controlled hardware element based on the value of the bit at the position in the bit register.

In Example 106, the subject matter of any one or more of Examples 91-105 optionally include wherein the means for using the n-bit security identifier comprise: means for comparing the n-bit security identifier to an expected value; and means for permitting or denying access to the access-controlled hardware element based on whether the n-bit security identifier corresponds with the expected value.

In Example 107, the subject matter of any one or more of Examples 105-106 optionally include wherein the requested operation comprises a read operation.

In Example 108, the subject matter of any one or more of Examples 105-107 optionally include wherein the requested operation comprises a write operation.

In Example 109, the subject matter of any one or more of Examples 105-108 optionally include wherein the requested operation comprises a change policy operation.

Example 110 is at least one machine-readable medium including instructions for using security identifiers, which when executed by a machine, cause the machine to perform the operations comprising: receiving, at an access-controlled hardware element, a security identifier having a length of m bits, transmitted to the access-controlled hardware element from a requesting hardware block, the security identifier transmitted with a requested operation; applying a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and using the n-bit security identifier to determine whether the requesting hardware block is permitted to perform the requested operation.

In Example 111, the subject matter of Example 110 optionally includes wherein the requesting hardware block comprises a processor core.

In Example 112, the subject matter of any one or more of Examples 110-111 optionally include wherein the requesting hardware block comprises a input/output device.

In Example 113, the subject matter of any one or more of Examples 110-112 optionally include wherein the access-controlled hardware element comprises a memory device.

In Example 114, the subject matter of any one or more of Examples 110-113 optionally include wherein the access-controlled hardware element comprises a graphics output device.

In Example 115, the subject matter of any one or more of Examples 110-114 optionally include wherein the security identifier comprises a security attributes of initiator value.

In Example 116, the subject matter of any one or more of Examples 110-115 optionally include -bit security attributes of initiator value.

In Example 117, the subject matter of any one or more of Examples 110-116 optionally include wherein the pool of security identifiers comprises a core pool.

In Example 118, the subject matter of any one or more of Examples 110-117 optionally include wherein the pool of security identifiers comprises a non-core pool.

In Example 119, the subject matter of any one or more of Examples 110-118 optionally include wherein the pool of security identifiers comprises a north bridge pool.

In Example 120, the subject matter of any one or more of Examples 110-119 optionally include wherein the pool of security identifiers comprises a south bridge pool.

In Example 121, the subject matter of any one or more of Examples 110-120 optionally include wherein the pool of security identifiers comprises a reserve pool.

In Example 122, the subject matter of any one or more of Examples 110-121 optionally include wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

In Example 123, the subject matter of Example 122 optionally includes wherein the first pool and second pool are arranged to allow a system designer to use an arbitrary version of the first type of hardware with an arbitrary version of the second type of hardware without producing a security identifier conflict.

In Example 124, the subject matter of any one or more of Examples 110-123 optionally include wherein using the n-bit security identifier comprises: referencing a bit register to determine a value of a bit at a position in the bit register that corresponds with the n-bit security identifier; and permitting or denying access to the access-controlled hardware element based on the value of the bit at the position in the bit register.

In Example 125, the subject matter of any one or more of Examples 110-124 optionally include wherein using the n-bit security identifier comprises: comparing the n-bit security identifier to an expected value; and permitting or denying access to the access-controlled hardware element based on whether the n-bit security identifier corresponds with the expected value.

In Example 126, the subject matter of any one or more of Examples 124-125 optionally include wherein the requested operation comprises a read operation.

In Example 127, the subject matter of any one or more of Examples 124-126 optionally include wherein the requested operation comprises a write operation.

In Example 128, the subject matter of any one or more of Examples 124-127 optionally include wherein the requested operation comprises a change policy operation.

Example 129 is at least one machine-readable medium including instructions, which when executed by a machine, cause the machine to perform operations of any of the operations of Examples 1-128.

Example 130 is an apparatus comprising means for performing any of the operations of Examples 1-128.

Example 131 is a system to perform the operations of any of the Examples 1-128.

Example 132 is a method to perform the operations of any of the Examples 1-128.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B.” “B but not A.” and “A and B.” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third.” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for security attribute pool allocation, the system comprising:
an integrated circuit to:
access a hardware block; and
store a security identifier in the hardware block, the security identifier being from a pool of security identifiers, the pool being one of a plurality of pools of security identifiers with each of the plurality of pools having mutually exclusive sets of security identifiers.

2. The system of claim 1, wherein the hardware block comprises a processor core.

3. The system of claim 1, wherein the hardware block comprises input/output device.

4. The system of claim 1, wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

5. The system of claim 4, wherein the first pool and second pool are arranged to allow a system designer to use an arbitrary version of the first type of hardware with an arbitrary version of the second type of hardware without producing a security identifier conflict.

6. A method of security attribute pool allocation, the method comprising:
accessing a hardware block; and
storing a security identifier in the hardware block, the security identifier being from a pool of security identifiers, the pool being one of a plurality of pools of security identifiers with each of the plurality of pools having mutually exclusive sets of security identifiers.

7. The method of claim 6, wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

8. The method of claim 7, wherein the first pool and second pool are arranged to allow a system designer to use an arbitrary version of the first type of hardware with an arbitrary version of the second type of hardware without producing a security identifier conflict.

9. A system for using security identifiers, the system comprising:
an integrated circuit to:
receive, at an access-controlled hardware element, a security identifier having a length of m bits, transmitted to the access-controlled hardware element from a requesting hardware block, the security identifier transmitted with a requested operation;
apply a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and
use the n-bit security identifier to determine whether the requesting hardware block is permitted to perform the requested operation.

10. The system of claim 9, wherein the requesting hardware block comprises a processor core.

11. The system of claim 9, wherein the requesting hardware block comprises a input/output device.

12. The system of claim 9, wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

13. The system of claim 12, wherein the first pool and second pool are arranged to allow a system designer to use an arbitrary version of the first type of hardware with an arbitrary version of the second type of hardware without producing a security identifier conflict.

14. The system of claim 9, wherein to use the n-bit security identifier, the integrated circuit is to:
reference a bit register to determine a value of a bit at a position in the bit register that corresponds with the n-bit security identifier; and
permit or deny access to the access-controlled hardware element based on the value of the bit at the position in the bit register.

15. The system of claim 9, wherein to use the n-bit security identifier, the integrated circuit is to:
compare the n-bit security identifier to an expected value; and
permit or deny access to the access-controlled hardware element based on whether the n-bit security identifier corresponds with the expected value.

16. A method of using security identifiers, the method comprising:
receiving, at an access-controlled hardware element, a security identifier having a length of m bits, transmitted to the access-controlled hardware element from a requesting hardware block, the security identifier transmitted with a requested operation;
applying a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and
using the n-bit security identifier to determine whether the requesting hardware block is permitted to perform the requested operation.

17. The method of claim 16, wherein the plurality of pools of security identifiers includes a first pool and a second pool, the first pool associated with a first type of hardware and the second pool associated with a second type of hardware, such that security identifiers for the first type of hardware are only selected from the first pool and security identifiers for the second type of hardware are only selected from the second pool.

18. The method of claim 17, wherein the first pool and second pool are arranged to allow a system designer to use an arbitrary version of the first type of hardware with an arbitrary version of the second type of hardware without producing a security identifier conflict.

19. The method of claim 16, wherein using the n-bit security identifier comprises:
referencing a bit register to determine a value of a bit at a position in the bit register that corresponds with the n-bit security identifier; and
permitting or denying access to the access-controlled hardware element based on the value of the bit at the position in the bit register.

20. The method of claim 16, wherein using the n-bit security identifier comprises:
comparing the n-bit security identifier to an expected value; and
permitting or denying access to the access-controlled hardware element based on whether the n-bit security identifier corresponds with the expected value.

21. The method of claim 20, wherein the requested operation comprises a read operation.

22. The method of claim 20, wherein the requested operation comprises a write operation.

23. The method of claim 20, wherein the requested operation comprises a change policy operation.

24. At least one non-transitory machine-readable medium including instructions for using security identifiers, which when executed by a machine, cause the machine to perform the operations comprising:
receiving, at an access-controlled hardware element, a security identifier having a length of m bits, transmitted to the access-controlled hardware element from a requesting hardware block, the security identifier transmitted with a requested operation;
applying a reduction function to the security identifier to obtain an n-bit security identifier, where m>n, and the n-bit security identifier is selected from a pool of security identifiers, the pool being one of a plurality of pools of security identifiers with each of the plurality of pools having mutually exclusive sets of security identifiers; and
using the n-bit security identifier to determine whether the requesting hardware block is permitted to perform the requested operation.

25. The at least one machine-readable medium of claim 24, wherein using the n-bit security identifier comprises:
referencing a bit register to determine a value of a bit at a position in the bit register that corresponds with the n-bit security identifier; and
permitting or denying access to the access-controlled hardware element based on the value of the bit at the position in the bit register.
